(19) United States
(12) Patent Application Publication
(10) Pub. No.: US 2008/0143640 A1
(43) Pub. Date: Jun. 19, 2008

(54) Electronic ink display device and active device array substrate

(75) Inventors: Yu-Chen Hsu, Hsinchu (TW); Chi-Ming Wu, Hsinchu (TW)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: PRIME VIEW INTERNATIONAL CO., LTD.

(21) Appl. No.: 11/797,273

(22) Filed: May 2, 2007

(30) Foreign Application Priority Data
Dec. 19, 2006 (TW) 95147733

(51) Int. Cl. G09G 3/20

(52) U.S. Cl. 345/55

(57) ABSTRACT

An electronic ink display device including an active device array substrate and a front panel is provided. The active device array substrate includes a first substrate, multiple scan lines and data lines, multiple pixel units, an electrostatic discharge (ESD) protection circuit and at least one conductive pattern electrically connected to the common electrode. The front panel is disposed at a side of the active device array substrate. The front panel includes a second substrate, a common electrode and an electronic ink material layer, wherein the conductive pattern is electrically connected with the ESD protection circuit. The electronic ink display device has good protecting ability of electrostatic discharge. Besides, an active device array substrate with good ESD protecting capability is also provided.

This application claims priority to Taiwan Application Serial Number 95147733, filed Dec. 19, 2006, which is herein incorporated by reference.

### FIELD OF THE INVENTION

The present invention relates to a display device and an active device array substrate, and more particularly, to an electronic ink display device (E-ink Display Device) and an active device array substrate having good electrostatic discharge (ESD) protecting capability.

### BACKGROUND OF THE INVENTION

With the advance of the modern video technology, various display devices have been massively applied on the display screens of the consumption electronic products such as cellar phones, notebook computers, digital cameras and personal digital assistants (PDAs), etc., wherein an electronic ink display device has the advantages of low power consumption, thin size, long operation life and flexibility, thus having high development potential.

FIG. 1A is a schematic diagram showing the structure of a conventional electronic ink display device. Such as shown in FIG. 1A, an electronic ink display device 10 includes a TFT (Thin-Film Transistor) array substrate 20 and a front panel 30, wherein the TFT array substrate 20 is formed by implementing a plurality of pixel units 24 (only one pixel unit is shown in FIG. 1A for explanation) on a substrate 21, and each pixel unit 24 includes a TFT 24a and a pixel electrode 24b electrically connected thereto. The front panel 30 is disposed on one side of the TFT array substrate 20, and includes a cover 32, a transparent electrode layer 34 and an electronic ink material layer 36. When an electric field is formed between the pixel electrode 24b and the transparent electrode layer 34, the electronic ink particles 36b in the electronic ink material layer 36 can be driven for displaying an image. In the conventional skill, the electronic ink material layer 36 can be formed from other material. For example, such as another electronic ink display device 10′ shown in FIG. 1B, an electronic ink material layer 36 includes a plurality of microcapsules 36b, and each of the microcapsules 36b includes a plurality of dark color particles 36b-1, a plurality of bright color particles 36b-2 and a transparent fluid 36b-3, wherein the dark color particles 36b-1 and the bright color particles 36b-2 are distributed in the transparent fluid 36b-3, and the electrical property of the dark color particles 36b-1 is opposite to that of the bright color particles 36b-2.

However, the process for manufacturing the electronic ink display device 10 or 10′ involves a lot of machines and human operations, and the machines and humans somehow carry static electricity. Hence, when the aforementioned charge-carriers (such as human bodies, machines or instruments) contact the electronic ink display device 10, the electronic ink display device 10 may be charged thereby, and the instantaneous of the electrostatic charging may cause the damages or failure to the TFTs 24a and circuits of the electronic ink display device 10.

Referring to FIG. 1C, FIG. 1C is schematic top view showing the TFT array substrate of the electronic ink display device shown in FIG. 1A. For preventing the problem of the damages caused by static electricity, an ESD protection circuit 26 is often placed in a peripheral circuit area 21b of the TFT array substrate 20. Such as shown in FIG. 1C, the TFT array substrate 20 comprises the substrate 21, scan lines 22, data lines 23, the pixel units 24 and the ESD protection circuit 26. It is worthy to be noted that the ESD protection circuit 26 is disposed in the peripheral circuit area 21b around a display area 21a, and switch elements 25 are located between the ESD protection circuit 26 the TFT array substrate 20. Consequently, when the electrostatic charges are accumulated on the substrate 21, the TFTs 24a in the display area 21a, the scan lines 22 or the data lines 23, the accumulated electrostatic charges will activate the switch elements 25, thereby transmitting the electrostatic charges to the ESD protection circuit 26, so that the TFTs 24a, the scan lines 22 or the data lines 23 will not be damaged by the accumulated electrostatic charges. However, if over excessive electrostatic charges are accumulated, the ESD protection circuit 26 will not be able to hold such a large amount of static electricity, thus still causing the elements or circuits on the TFT array substrate 20 to be damaged, and lowering the production yield of the electronic ink display device 10.

### SUMMARY OF THE INVENTION

One aspect of the present invention is to provide a display device with good protecting capability.

Another aspect of the present invention is to provide an active device array substrate with good protecting capability.

According to an embodiment of the present invention, the electronic ink display device comprises an active device array substrate and a front panel. The active device array substrate comprises a first substrate, a plurality of scan lines and a plurality of data lines, a plurality of pixel units, an ESD protection circuit and at least one conductive pattern electrically connected to the common electrode. The first substrate has a display area and a peripheral circuit area disposed around the display area. The scan lines and the data lines are disposed on the first substrate. The pixel units are disposed in the display area of the first substrate, and each of the pixel units is electrically connected to its corresponding scan line and data line respectively. The ESD protection circuit is disposed in the peripheral circuit area of the first substrate, and is electrically coupled to the scan lines and the data lines. The conductive pattern is disposed in the peripheral circuit area of the first substrate, and is electrically coupled to the ESD protection circuit. The front panel is disposed at one side of the active device array substrate, and comprises a second substrate, a common electrode and an electronic ink material layer. The common electrode is disposed on the second substrate. The electronic ink material layer is disposed between the common electrode and the active device array substrate.

According to the embodiment of the present invention, the active device array substrate comprises a first substrate, a plurality of scan lines and a plurality of data lines, a plurality of pixel units, an ESD protection circuit, and at least one conductive pattern layer electrically connected to the common electrode. The first substrate has a display area and a peripheral circuit area disposed around the display area. The scan lines and the data lines are disposed on the first substrate. The pixel units are disposed in the display area of the first substrate, and each of the pixel units is electrically connected to its corresponding scan line and data line respectively. The ESD protection circuit is disposed in the peripheral circuit area of the first substrate, and is electrically coupled to the scan lines and the data lines. The conductive pattern is disposed in the peripheral circuit area of the first substrate, and is electrically coupled to the ESD protection circuit.

According to another embodiment of the present invention, the ESD protection circuit comprises an inner short ring (ISR). Further, the electronic ink display device comprises a plurality of protection elements disposed in the peripheral circuit area of the first substrate, and the protection elements are electrically connected to the ESD protection circuit.

According to another embodiment of the present invention, the protection elements comprise an active element or a passive element.

According to another embodiment of the present invention, the protection elements comprise a TFT or a diode.

According to another embodiment of the present invention, each of the of pixel units comprises an active element and a pixel electrode. The active element is electrically connected to its corresponding scan line and data line. The pixel electrode is electrically connected to the active element. Further, the active element comprises a TFT or a diode.

According to another embodiment of the present invention, the electronic ink material layer comprises a plurality of electronic ink particles and a transparent fluid, and the electronic ink particles are distributed in the transparent fluid. The electronic ink particles comprise a plurality of dark color particles and a plurality of bright color particles.

According to another embodiment of the present invention, the electronic ink display device further comprises a plurality of microcapsules, wherein the dark color particles, the bright color particles and the transparent fluid are enclosed in the microcapsules.

According to another embodiment of the present invention, the electronic ink material layer comprises a plurality of electronic ink particles, wherein one half of each electronic ink particle is bright in color, and the other half of each electronic ink particle is dark in color, and both halves of each electronic ink particle have opposite electrical properties.

On the active device array substrate of the electronic ink display device, a conductive pattern is disposed in the peripheral circuit area thereof, and is electrically connected to the ESD protection circuit. Hence, when a large amount of electrostatic charges are accumulated on the active device array substrate, the electrostatic charges can be further released to the conductive pattern in addition to the ESD protection circuit. Besides, the conductive pattern is also electrically connected to the common electrode, and thus the electrostatic charges can be further transmitted to the common electrode of the front panel. Therefore, the electronic ink display device according to the embodiments of the present invention has better efficacy of ESD protection, and the production yield thereof can be promoted.

### BRIEF DESCRIPTION OF THE DRAWINGS

The foregoing aspects and many of the attendant advantages of this invention are more readily appreciated as the same become better understood by reference to the following detailed description, when taken in conjunction with the accompanying drawings, wherein:

FIG. 1A is a schematic diagram showing the structure of a conventional electronic ink display device;

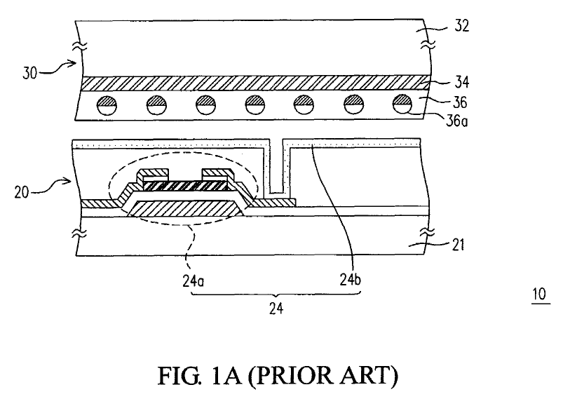

FIG. 1B is a schematic diagram showing the structure of another conventional electronic ink display device;

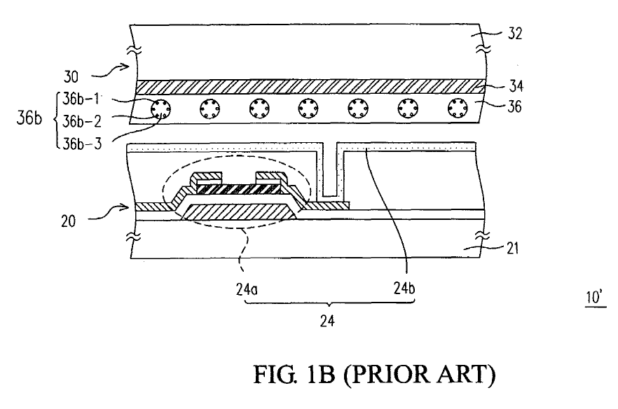

FIG. 1C is a schematic top view showing the TFT array substrate of the electronic ink display device shown in FIG. 1A

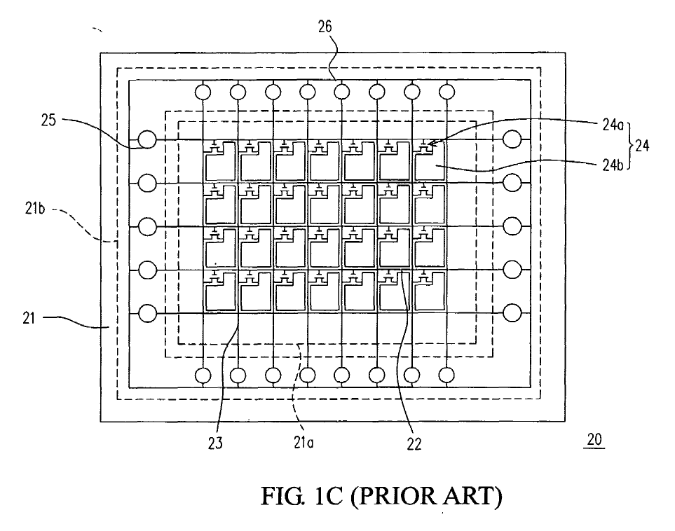

FIG. 2A is a schematic diagram showing the structure of an electronic ink display device according to an embodiment of the present invention;

FIG. 2B is a schematic top view showing an active device array substrate of the electronic ink display device according to the embodiment of the present invention;

FIG. 2C is a schematic diagram of locally enlarging an area S10 shown in FIG. 2B; and

FIG. 2D is a schematic view showing the connection between a conductive pattern and a common electrode, wherein FIG. 2D is a schematic cross-sectional diagram viewed along line C-C′ of FIG. 2B.

### DETAILED DESCRIPTION OF THE PREFERRED EMBODIMENT

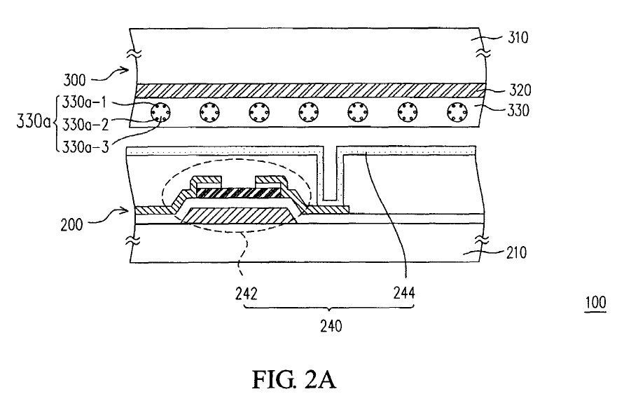

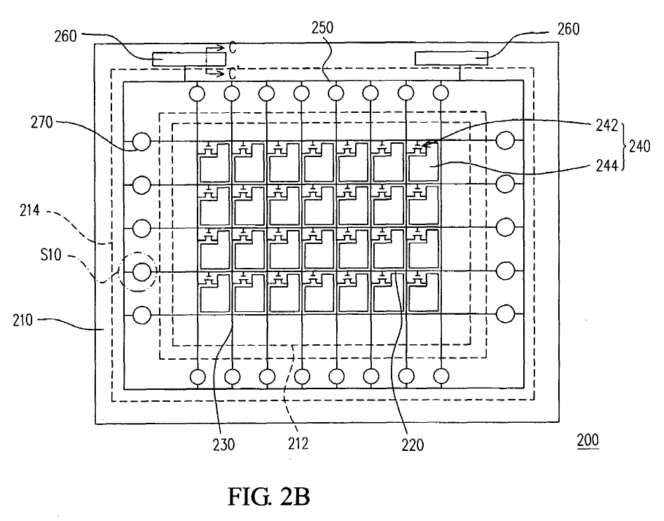

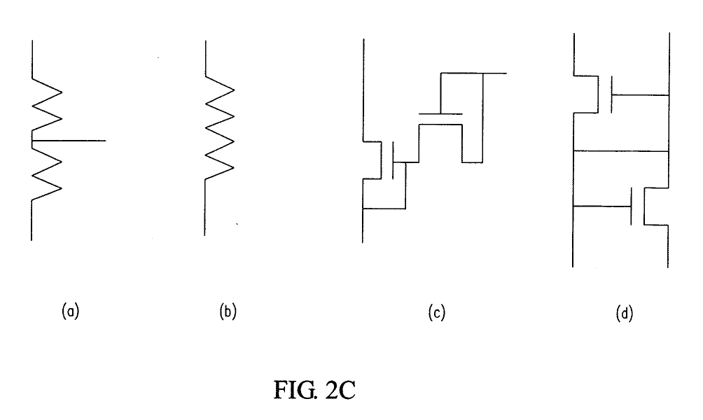

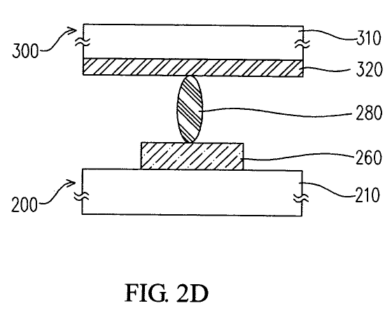

FIG. 2A is a schematic diagram showing the structure of an electronic ink display device according to an embodiment of the present invention, and FIG. 2B is a schematic top view showing an active device array substrate of the electronic ink display device according to the embodiment of the present invention. Referring to FIG. 2A and FIG. 2B simultaneously, the electronic ink display device 100 comprises an active device array substrate 200 and a front panel 300. The active device array substrate 200 comprises a first substrate 210, a plurality of scan lines 220, a plurality of data lines 230, a plurality of pixel units 240, an ESD protection circuit 250 and at least one conductive pattern 260. The first substrate 210 has a display area 212 and a peripheral circuit area 214 disposed around the display area 212. The scan lines 220 and the data lines 230 are disposed on the first substrate 210. The pixel units 240 are disposed in the display area 212 of the first substrate 210, and each of the pixel units 240 is electrically connected to its corresponding scan line 220 and data line 230 respectively. The ESD protection circuit 250 is disposed in the peripheral circuit area 214 of the first substrate 210. The conductive pattern 260 is disposed in the peripheral circuit area 214 of the first substrate 210, and is electrically coupled to the ESD protection circuit 250. The front panel 300 is disposed at one side of the active device array substrate 200, and comprises a second substrate 310, a common electrode 320 and an electronic ink material layer 330. The common electrode 320 is disposed on the second substrate 310. The electronic ink material layer 330 is disposed between the common electrode 320 and the active device array substrate 200.

Please refer to FIG. 2B again. In one embodiment, the ESD protection circuit 250 is an inner short ring (ISR). Alternatively, in another embodiment, the ESD protection circuit 250 is a circuit having an inner short ring and an outer short ring (OSR; not shown) simultaneously. Further, although the ESD protection circuit 250 shown in FIG. 2B is an annular circuit enclosing the display area 212, yet the ESD protection circuit 250 is not limited thereto. In other embodiments, the ESD protection circuit (not shown) also can be a non-close loop circuit. Therefore, the shape of the ESD protection circuit 250 is not limited herein.

Meanwhile, the ESD protection circuit 250 of the electronic ink display device 100 comprises a plurality of protection elements 270 which are disposed in the peripheral circuit area 214 of the first substrate 210 and are electrically coupled to the ESD protection circuit 250. In one embodiment, the protecting elements 270 include active elements or passive elements, i.e. the protecting elements 270 can be TFTs, diodes, the switch elements with three terminals or other proper elements. FIG. 2C is a schematic diagram of locally enlarging an area S10 shown in FIG. 2B, and several types of protection elements 270 are depicted in FIG. 2C.

Further, each of the pixel units 240 shown in FIG. 2B comprises an active element 242 and a pixel electrode 244, wherein the active element 242 is electrically connected to its corresponding scan line 220 and data line 230, and the pixel electrode 244 is electrically connected to the active element 242. The active element 242 is used as a switch element of the pixel unit 240, whereby a data voltage can be applied to the pixel electrode 244 by driving the active element 242 via the scan line 220 and the data line 230. In one embodiment, the active element 242 can be a TFT, a diode or a switch element with three terminals.

Consequently, when over excessive electrostatic charges are accumulated on the active elements 242, the scan lines 220 or the data lines 230 on the first substrate 210 or the display area 212, the accumulated electrostatic charges will activate the protection elements to transmit the electrostatic charges to the ESD protection circuit 250, thus preventing the elements and circuits in the display area 212 from being damaged by the electrostatic charges.

It is worthy to be noted that: since the ESD protection circuit 250 of this embodiment is electrically coupled to the conductive pattern 260, the electronic ink display device 100 of this embodiment can endure stronger electrostatic discharge. Detailedly speaking, when the elements or circuits on the first substrate 210 or the display area 212 have accumulated over excessive electrostatic charges and the ESD protection circuit 250 fails to endure such a large amount of electrostatic charges, the electrostatic charges still can be conducted to the conductive pattern 260, thus achieving the efficacy of releasing the electrostatic charges. In comparison with the conventional electronic ink display device 10, the electronic ink display device 100 of this embodiment has better ESD protection efficacy.

In one embodiment, the aforementioned conductive patter 260 can be any conductive pattern having a larger area in the peripheral circuit area 214. For example, the conductive pattern 260 can a bond pad used for applying a common voltage (Vcommon). Besides, the material of the conductive pad 260 can be metal or other proper electrically-conductive material.

It is further worthy to be noted that: the conductive pattern 260 of this embodiment can be electrically connected to the common electrode 320. FIG. 2D is a schematic view showing the connection between a conductive pattern and a common electrode, wherein FIG. 2D is a schematic cross-sectional diagram viewed along line C-C′ of FIG. 2B. Referring FIG. 2D, the conductive pattern 260 is electrically connected to the common electrode 320 located on the front panel 300 via silver glue 280. Certainly, the conductive pattern 260 also can be electrically connected to the common electrode 320 via other methods. Since the common electrode 320 has a larger area, and thus more electrostatic charges can be conducted to the common electrode 320, thereby enabling the electronic ink display device 100 to have better ESD protection efficacy.

For fabricating the active device array substrate 200, a plurality of active device arrays are first formed simultaneously on an entire sheet of glass substrate (not shown), and then the active device arrays are divided into independent active device array substrates 299. Before dividing, the ESD protection circuits 250 of the respective active device arrays are electrically connected to a common ground (not shown) on the glass substrate for performing ESD protection. However, after the glass substrate is divided into the plurality of active device array substrates 200, the common ground is interrupted and loses the ESD protection function.

However, after the dividing step is performed to form the plurality of active device array substrates 200, the conductive pattern 260 of the present embodiment still remains on each active device array substrates 200, so that the conductive pattern 260 still has the ESD protection towards the elements or circuits. Thus, the conductive pattern 260 can consistently protect the elements or circuits during the fabrication process, thereby promoting the production yield of the electronic ink display device.

Regarding the materials of the respective components, the following description is provided as an example for explanation. Continuously referring to FIG. 2A and FIG. 2B, the material of the first substrate 210 is such as glass, quartz or other flexible materials. The material forming the scan line 220 and the data line 230 can be such as aluminum, chromium, aluminum alloy, chromium alloy or other appropriate electrically-conductive materials. The material of the common electrode 320 can be such as transparent electrically-conductive material or other appropriate materials, wherein the transparent electrically-conductive material can be selected from indium tin oxide (ITO), indium zinc oxide (IZO) and a combination thereof. The material of the pixel electrode 244 can be such as transparent electrically-conductive material, metal or other appropriate materials, wherein the transparent electrically-conductive material can be selected from indium tin oxide (ITO), indium zinc oxide (IZO) and a combination thereof.

Continuously referring to FIG. 2A, according this embodiment, the electronic ink material layer 330 of the electronic ink display device 100 comprises a plurality of microcapsules 330a, and each of the microcapsules 330a includes a plurality of dark color particles 330a-1, a plurality of bright color particles 330a-2 and a transparent fluid 330a-3, wherein the dark color particles 330a-1 and the bright color particles 330a-2 are distributed in the transparent fluid 330a-3, and the electrical property of the dark color particles 330a-1 is opposite to that of the bright color particles 330a-2. When an electric field is generated between the pixel electrode 244 and the common electrode 320, the dark color particles 330a-1 and the bright color particles 330a-2 can be driven for displaying an image. However, this present invention is not limited to the type of the electronic ink material layer 330. In another embodiment, the electronic ink material layer 330 also can include a plurality of electronic ink particles (not shown), wherein one half of each electronic ink particle is bright in color, and the other half of each electronic ink particle is dark in color, and both halves of each electronic ink particle have opposite electrical properties. Similarly, when an electric field is generated between the pixel electrode 244 and the common electrode 320, the electronic ink particle can be driven for displaying an image.

To sum up, the electronic ink display device and the active device array substrate of the present invention has the following advantages.

(1) The conductive pattern is disposed in the peripheral circuit area of the active device array substrate, and is electrically coupled to the ESD protection circuit. Hence, when a large amount of electrostatic charges are accumulated on the display area, the electrostatic charges can be further released to the conductive pattern in addition to the ESD protection circuit.

(2) Since the conductive pattern is electrically connected to the common electrode of the front panel, the electrostatic charges can be further conducted to the common electrode, so that the electronic ink display device of the present invention has good ESD protection efficacy.

(3) Since the conductive pattern is disposed on the active device array substrate and is electrically coupled to the ESD protection circuit, the conductive pattern can consistently protect the elements or circuits during the fabrication process, thus promoting the production yield of the electronic ink display device.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. An electronic ink display device, comprising:
an active device array substrate, comprising:
a first substrate having a display area and a peripheral circuit area disposed around said display area;
a plurality of scan lines and a plurality of data lines disposed on said first substrate;
a plurality of pixel units disposed in said display area of said first substrate, and each of said pixel units is electrically connected to its corresponding scan line of said scan lines and its corresponding data line of said data lines respectively;
an electrostatic discharge (ESD) protection circuit disposed in said peripheral circuit area of said first substrate, wherein said ESD protection circuit is electrically coupled to said scan lines and said data lines; and
at least one conductive pattern disposed in said peripheral circuit area of said first substrate, wherein said conductive pattern is electrically coupled to said ESD protection circuit; and
a front panel disposed at one side of said active device array substrate, said front panel comprising:
a second substrate;
a common electrode disposed on said second substrate, and;
an electronic ink material layer disposed between said common electrode and said active device array substrate.

2. The electronic ink display device of claim 1, wherein said conductive pattern is electrically connected to said common electrode.

3. The electronic ink display device of claim 1, wherein said ESD protection circuit comprising an inner short ring (ISR).

4. The electronic ink display device of claim 1, further comprising a plurality of protection elements disposed in said peripheral circuit area of said first substrate, wherein said protection elements are electrically connected to said ESD protection circuit.

5. The electronic ink display device of claim 4, wherein said protection elements comprise an active element or a passive element.

6. The electronic ink display device of claim 4, wherein said protection elements comprise a thin-film transistor (TFT) or a diode.

7. The electronic ink display device of claim 1, wherein each of said pixel units comprises:
an active element electrically connected to its corresponding scan line of said scan lines and its corresponding data line of said data lines; and
a pixel electrode electrically connected to said active element.

8. The electronic ink display device of claim 7, wherein said active element comprises a thin-film transistor (TFT) or a diode.

9. The electronic ink display device of claim 1, wherein said electronic ink material layer comprises a plurality of electronic ink particles and a transparent fluid, and said electronic ink particles are distributed in said transparent fluid.

10. The electronic ink display device of claim 9, wherein said electronic ink particles comprise a plurality of dark color particles and a plurality of bright color particles.

11. The electronic ink display device of claim 10, further comprising: a plurality of microcapsules, wherein said dark color particles, said bright color particles and said transparent fluid are enclosed in said microcapsules.

12. The electronic ink display device of claim 1, wherein said electronic ink material layer comprises a plurality of electronic ink particles, and one half of each of said electronic ink particles is bright in color, and the other half of each of said electronic ink particles is dark in color, and said both halves of each of said electronic ink particles have opposite electrical properties.

13. An active device array substrate, comprising:
a first substrate having a display area and a peripheral circuit area disposed around said display area;
a plurality of scan lines and a plurality of data lines disposed on said first substrate;
a plurality of pixel units disposed in said display area of said first substrate, and each of said pixel units is electrically connected to its corresponding scan line of said scan lines and its corresponding data line of said data lines respectively;
an electrostatic discharge (ESD) protection circuit disposed in said peripheral circuit area of said first substrate, wherein said ESD protection circuit is electrically coupled to said scan lines and said data lines; and
at least one conductive pattern disposed in said peripheral circuit area of said first substrate, wherein said conductive pattern is electrically coupled to said ESD protection circuit.

14. The active device array substrate of claim 13, wherein said conductive pattern is electrically connected to a common electrode.

15. The active device array substrate, of claim 13, wherein said ESD protection circuit comprising an inner short ring.

16. The active device array substrate of claim 13, further comprising a plurality of protection elements disposed in said peripheral circuit area of said first substrate, wherein said protection elements are electrically connected to said ESD protection circuit.

17. The active device array substrate of claim 16, wherein said protection elements comprise an active element or a passive element.

18. The active device array substrate of claim 16, wherein said protection elements comprise a thin-film transistor (TFT) or a diode.

19. The active device array substrate of claim 13, wherein each of said pixel units comprises:
an active element electrically connected to its corresponding scan line of said scan lines and its corresponding data line of said data lines; and
a pixel electrode electrically connected to said active element.

20. The active device array substrate of claim 19, wherein said active element comprises a thin-film transistor (TFT) or a diode.
